(19) United States
(12) Patent Application Publication
(10) Pub. No.: US 2026/0219139 A1
(43) Pub. Date: Jul. 30, 2026

(54) SAMPLE REMOVAL DEVICE FOR REMOVING A SAMPLE FROM A SYSTEM PART CONVEYING A LIQUID MEDIUM, AND METHOD FOR REMOVING SUCH A SAMPLE

(71) Applicant: DEUTSCHES ZENTRUM FÜR LUFT- UND RAUMFAHRT E.V., Bonn (DE)

(72) Inventors: Alexander BONK, Stuttgart (DE); Ralf HOFFMANN, Stuttgart (DE); Markus BRAUN, Stuttgart (DE); Wenjin DING, 70569 (DE); Qing GONG, Stuttgart (DE)

(21) Appl. No.: 19/148,694

(22) PCT Filed: Feb. 20, 2024
(86) PCT No.: PCT/EP2024/054315

§ 371 Date: Jul. 17, 2025

(30) Foreign Application Priority Data
Feb. 24, 2023 (DE) 10 2023 104 568.7

(51) Int. Cl. G01N 1/20; G01N 1/10

(52) U.S. Cl. CPC G01N 1/2035; G01N 2001/1068; G01N 2001/205

(57) ABSTRACT

The invention relates to a sample removal device (1) for removing a sample from a liquid medium located in a system, with a sample holder (16) into which the removed sample can be introduced via a feed device. A defined, reproducible sample removal from a system is achieved in that the feed device has a line arrangement (4) which is provided on the inlet side with a connection unit (10) which is or can be coupled in a medium-conducting manner to a system part (2) of the system and on the outlet side with a discharge portion which is or can be brought into connection, in a medium-conducting manner, with the sample holder (16), and has an openable and closable closure device.

The invention relates to a sample removal device for removing a sample from a liquid medium located in a system, with a sample holder into which the removed sample can be introduced via a feed device, and to a method for removing a sample from a liquid medium located in a system part by means of a sample holder into which the sample is introduced via a feed device, and further to a use of such a sample holder device and an application of the method.

A sample removal device of this type for removing a sample from a liquid medium conducted in a system, as specified in EP 2 405 251A2 , has a feed device which is coupled or can be coupled to a suitable location in the system and to which a holder is assigned on the outlet side in order to feed the sample removed from the liquid medium to this holder in a specific quantity.

Another sample removal device and a method for removing a sample from a liquid medium conducted in a system, in particular for the analysis of biological material, is shown in U.S. Pat. No. 5,902,746 A. To form a seal at various points in a pipe system, the liquid medium can be frozen and the seal can be opened again by supplying electrical energy while heating.

A sample removal device shown in DE 1 955 988 A is designed in particular for taking samples of liquid metals and for chemically analyzing liquid metal melts for impurities in nuclear reactor circuits.

The repeated taking of a sample from a liquid medium in a system is useful, and often even necessary, in order to detect changes in the properties of the medium by analyzing the sample. For example, by regularly taking and analyzing samples taken from the liquid medium during operation of the system, such as a chemical reactor, thermal storage device or other storage device that uses e.g. molten inorganic salts, nitrate salts, chloride salts or carbonate salts at temperatures of 150° C. to 800° C. as a working medium or heat transfer medium, the long-term stability of the salt and of components that come into contact with it can be checked and suitable measures can be taken. In such systems, removing a sample using conventional sample removal devices of the type mentioned is cumbersome, time-consuming and potentially dangerous due to manual sample removal. However, failure to take samples, such as from salt-based systems, can lead to problems with salt corrosion, such as thermally induced decomposition reactions or corrosion reactions, not being detected in time. This can also lead to components corroding without being noticed, the salt decomposing and thus causing unforeseen system failures or even health hazards.

The present invention is based on the object of providing a sample removal device of the type mentioned at the outset, with which an automated removal of samples from the ongoing operation of a system or from a system part thereof (such as a pipeline, tank, or other components) is made possible as safely and reproducibly as possible, and of specifying a corresponding method and an application.

This object is achieved for the sample removal device with the features of claim 1 and for the method with the features of claim 14. A use of the sample removal device is specified in claim 17 and an application of the method is specified in claim 18.

In the sample removal device, it is provided that the feed device has a line arrangement which is provided on the inlet side with a connection unit which is or can be coupled in a medium-conducting manner to a system part of the system and on the outlet side with a discharge portion which is or can be brought into connection, in a medium-conducting manner, with the sample holder, and has an openable and closable closure device.

By means of the line arrangement coupled to the system part in a medium-conducting manner and the sample holder connected to the outlet side in a medium-conducting manner, as well as the openable and closable closure device, an automated removal of samples is achieved during ongoing operation of the system without endangering persons, so that a practical repeated and reproducible removal of the samples is possible, in particular even at higher temperatures of e.g. between 100° C. and 1600° C., preferably between 150° C. and 800° C., as in the case of molten inorganic salts found in a system as a working medium or heat transfer medium. Automated sample removal designed in this way can also be considered for other liquid media, for example corrosive media. The sample removal can be carried out, controlled, or regulated precisely using a control device.

Corresponding advantages also result in the method, in which it is provided that a line arrangement of the feed device is connected to the system part and a defined amount of the medium is fed as a sample into the sample holder by opening the flow path through the line arrangement, and after reaching the defined amount in the sample holder, the flow path is closed.

Corresponding advantages also result from the use of the sample removal device according to claim 17 and the application of the method according to claim 18.

The fact that the feed device has a pressure reduction device in an inlet region contributes to precise sample removal.

A precisely reproducible, defined sample removal is further facilitated by the fact that the pressure reducing device has a pipe with a reduced cross section relative to the connection unit or a nozzle part with a narrowing part directed towards the inlet side.

Precise controllability, or regulability, and thus also reproducibility of the sample removal is advantageously further promoted by the fact that the pressure reduction device has a pressure compensation device or flow limiting device arranged downstream of the optional nozzle part, in particular designed as a passive fluidic valve, for example a Tesla valve.

Further advantages for a metered sampling result from the fact that the feed device has a laminarization portion, in particular designed as a dosing lance, wherein the laminarization portion is arranged downstream of the pressure reduction device in the flow direction when designed according to one of claims 2 to 4.

Furthermore, there are advantages for the control or regulation of the sample removal in that the closure device can be controlled automatically and/or in a time-dependent manner depending on the sample size to be taken and/or the temporal sequence of the sampling.

A reliable functioning of the closure device and a design that protects the components are obtained in that the closure device, preferably arranged in the outlet region of the feed device, has a temperature-control device which, for closing, has a freezing device which forms a sealing plug by freezing the medium, in particular by free or forced convection, and, for opening, has a heating device which dissolves the sealing plug, in particular by preventing the convection by means of an insulating body or air flow inhibitor.

A design which is advantageous for the function consists in that the freezing device has a fan which generates a cooling air flow around a line portion of the line arrangement, in particular around the laminarization portion.

Further advantages for the design are obtained in that the heating device has an actively energized trace heating system and/or is operated passively using the heat of the supplied medium.

The fact that the temperature control device has a heat-conducting unit that is connected to the line arrangement in a heat-conducting manner, and in particular has cooling fins, are measures that contribute to the good functioning and efficiency of the temperature control device.

Precise controllability or regulability of the sample removal is also advantageously supported by the fact that the feed device has a pressure difference regulating device assigned to the line arrangement, which device comprises a pressure regulating unit arranged in a bypass line and effecting a pressure difference regulation, in particular over the region of the temperature control device.

An advantageous design of the sample removal device further consists in that the feed device is provided on the outlet side with an adjusting device having a sample removal part and a waste removal part, which comprises an adjusting part mounted on a support unit, wherein the sample holder is assigned to the sample removal part and a waste holder is assigned to the waste removal part. The adjustment part is preferably held on the system part with a fastening part.

A further advantageous embodiment for the structure and function is that the adjustment device is designed as a linear table or rotary table, which further comprises a guide part and a drive unit for adjusting the adjustment part from a rest position in which the discharge portion of the line arrangement is closed, into a waste removal position in which the waste removal part is assigned to the discharge portion of the line arrangement or into a sample removal position in which the sample removal part is assigned to the discharge portion of the line arrangement, and back.

Advantageous embodiments of the method consist in that the flow path is closed by freezing the medium in a portion of the line arrangement to form a sealing plug and that the flow path is opened by dissolving the sealing plug by means of heat, and further in that, before taking the sample, a waste quantity of the medium located at least in the line arrangement is conducted into a waste holder by opening the flow path and then closing it.

The invention is explained in more detail below by means of examples with reference to the drawings. In the drawings:

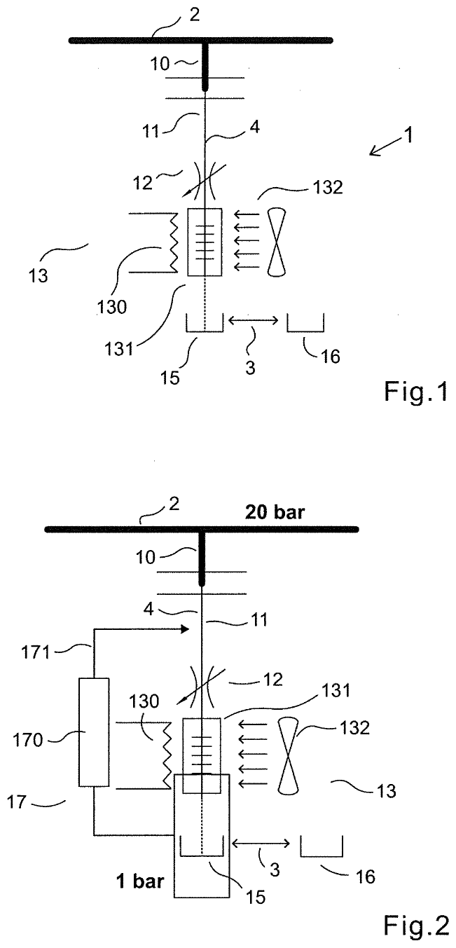

FIG. 1 is a schematic representation of a sample removal device connected to a system part of a system,

FIG. 2 shows a sample removal device according to FIG. 1 supplemented with a pressure difference regulation device,

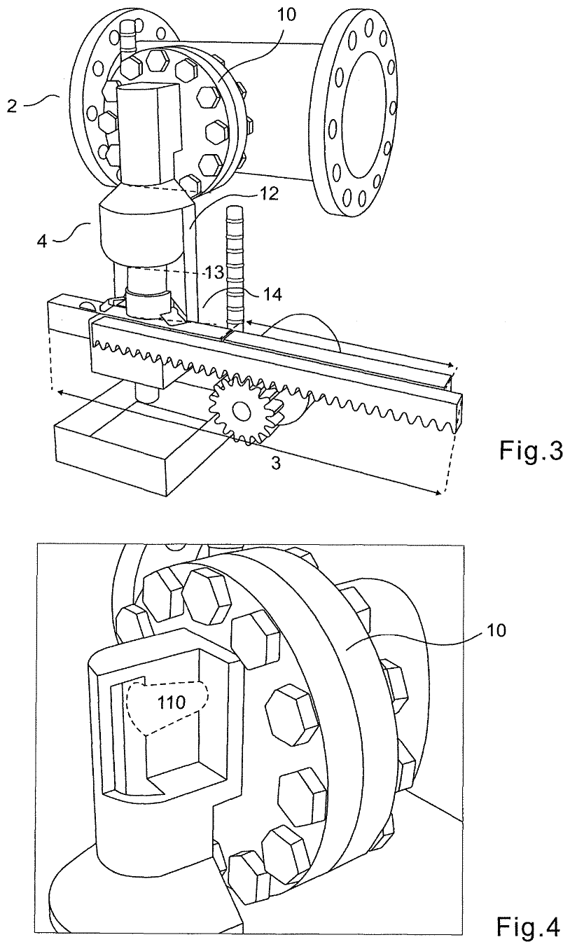

FIG. 3 shows another embodiment of the sample removal device in a perspective view,

FIG. 4 shows a partially cut-away detail of the sample removal device according to FIG. 3 in its connection area on the system part, and

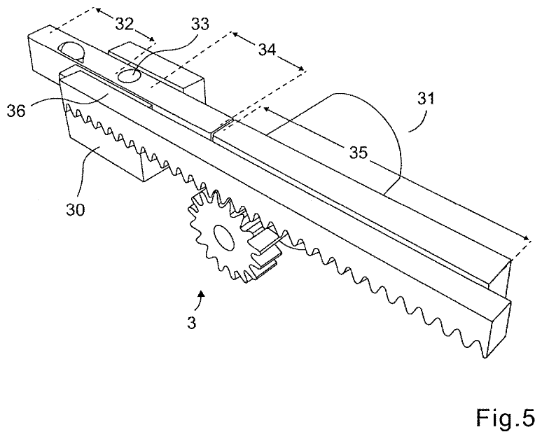

FIG. 5 shows a further detail of the sample removal device according to FIG. 3 in its holding area for the sample.

FIG. 1 shows an embodiment of a sample removal device 1 which is coupled to a system part 2 of a system (not shown in detail) by means of a connection unit 10. The system with system part 2 carries a liquid medium which generally has a corrosive effect on system components that come into contact with it. For example, the system is a chemical reactor or thermal or other storage device that uses, for example, molten inorganic salt, such as nitrate salt, chloride salt or carbonate salt, at a higher temperature in the range between 100° C. and 1600° C., often between 150° C. and 800° C., as a working medium or heat transfer medium. The liquid medium is usually under increased pressure, e.g. in the order of a few bar or a few tens of bar.

The sample removal device 1 has a feed device comprising the connection unit 10 and a line arrangement 4 connected thereto, via which a sample taken from the liquid medium conducted in the system is fed into a sample holder 16. Following the connection unit 10, the line arrangement 4 has a pipe 11 with a reduced cross section compared to the inlet portion of the connection unit 10, which leads to the sample holder 16 via a pressure equalization device 12 or a flow limiter, which is designed for example as a Tesla valve, via a further portion of the line arrangement 4 in which a closure device is arranged. In the exemplary embodiment shown, the sample holder 16, alternating with a waste holder 15, such as a waste container, can be assigned to a discharge portion of the line arrangement 4 provided with a discharge. A specifiable or specified quantity of the liquid medium taken from the system can be set automatically by corresponding time-dependent and/or quantity-dependent actuation of a control device that controls the sample removal device 1, in particular the closure device, in order to obtain a defined sample, for example also under control by means of a control device. This results in reproducible sample removal, e.g. at predefined time intervals or depending on events, without endangering an operator and/or operator-dependent error influences.

In the embodiment shown in FIG. 1, the closure device is designed in a particular way by means of a temperature-control device 13. In this case, in order to close the line arrangement 4, in particular in its outlet area, a part of the removed liquid medium itself is used as a closure element in that it is cooled by means of the temperature-control device 13 in a portion of the line arrangement 4 to below its solidification temperature, so that a sealing plug is formed by freezing. For this purpose, the temperature control device 13 has a cooling device, for example comprising a fan 132, by means of which a cooling air flow is generated around the relevant line portion carrying the liquid medium. For heat dissipation, the line portion is expediently provided with a heat-conducting unit 131, for example having cooling fins. The sealing plug eliminates the need for other closure components and prevents corrosion reactions and the resulting functional impairments. In order to guide the liquid medium to be conducted through for sampling into the sample holder 16, the fan 132 can be switched off and the heat of the supplied liquid medium itself can be used as a passive heat source. Alternatively or additionally, the temperature control device 13 is provided with a heating device 130 as a trace heating element, which is designed for example as an electrical heating device, and whose heat is supplied, for example when the fan 132 is switched on, via the heat-conducting unit 131 to the line portion with the sealing plug, which thereby dissolves or melts, so that the liquid medium enters the sample holder 16 in a regulated manner. The amount of liquid medium guided through the line arrangement 4, in particular also the relevant portion thereof, as well as the cooling capacity of the temperature control device 13 and the heating energy are coordinated with one another in such a way that a relevant amount of the liquid medium reaches the sample holder 16 as a sample under control or regulation of the closure device thus designed by means of the control device.

As further shown in FIG. 1 and mentioned above, the sample removal device 1 also has the waste holder 15, which can be assigned to the discharge of the line arrangement 4 in a waste removal function instead of to the sample holder 16 by means of the adjustment device 3. This makes it possible to separate at least a portion of the medium located in the line arrangement 4 that is not relevant for the sample or its analysis before a sample is taken. For this purpose, too, the closure device, for example the temperature-control device 13, can be controlled by supplying heat in such a way that the line arrangement 4 for discharging the waste quantity of the liquid medium into the waste holder 15 is opened by dissolving the sealing plug. Subsequently, the sample holder 16 can then be assigned again to the discharge of the line arrangement 4 in order to take a relevant (current) quantity of the liquid medium from the system as a sample. In order to move the waste holder 15 from the waste removal position and to move the sample holder 16 into the sample removal position, the line arrangement 4 can be closed by actuating the closure device, for example by forming the sealing plug.

The sample removal device 1 shown in FIG. 1 therefore works, for example, as follows: before sample removal, all controllable components, in particular the closure device or temperature-control device 13, are switched off. The heat-conducting unit 131, in particular the cooling fins, are dimensioned such that free convection is sufficient to dissipate the heat coming from the hot system part 2 and to hold a solidified sealing plug or salt plug in the region of the line arrangement 4 with the heat-conducting unit 131. The waste holder 15 with the waste container is assigned to the discharge portion or arranged below the discharge.

For the rinsing process with the waste removal function, both the fan 132 and the heat source of the heating device 130 are switched off. The heating device 130 is dimensioned such that it can quickly melt the sealing plug in the relevant portion of the line arrangement 4 despite the additional cooling effect of the fan 132. Once the sealing plug has melted, the medium or liquid salt flows into the waste holder with the waste container. The medium flow or salt flow is regulated by the pressure compensation device 12 or the flow limiter, in particular in the form of the Tesla valve.

To remove a sample, the heating device 130 can now be switched off briefly, whereby the temperature in the relevant portion of the line arrangement 4 drops extremely due to the strong cooling effect of the fan 132 and a sealing plug is formed again. The medium flow is now briefly interrupted. The sample holder 16 with a sample container is now assigned to the discharge portion or moved under the discharge thereof. The heating device 130 with the heat source is now switched on again and the sealing plug melts again. The medium now flows in a regulated manner through the pressure equalization device 12 or the flow limiter, in particular the Tesla valve, into the sample holder 16. An interruption of the medium flow can also be dispensed with.

After sample removal, the heating device 130 is first switched off. The fan 132 initially remains switched on in order to reduce the temperature in the relevant portion of the line arrangement 4 as quickly as possible. A sealing plug forms again. Now the fan 132 is also switched off.

In this way, liquid molten salt, for example, can be advantageously defined as a liquid medium and reproducibly extracted from a relevant system, such as from a thermal energy storage device in the field of solar thermal power plants or from salt-guided reactors, such as endo-or exothermic reactors.

In the embodiment shown in FIG. 2, compared to the design according to FIG. 1, a pressure difference regulating device 17 is additionally present, which has a bypass to the line arrangement 4 with a pressure regulating unit 170. The bypass is connected on the inlet side to the outlet region of the line arrangement 4 and the region of the waste holder 15 or sample holder 16 arranged there, and is led back into a region in the flow direction upstream of the temperature control device 13 or the pressure equalization device 12, e.g. to the pipeline 11, as can be seen from FIG. 2. The pressure difference regulating device 17 thus regulates the pressure difference between the internal system pressure and a sample chamber in which the sample is taken from the line arrangement 4, wherein the pressure difference regulator has self-regulating components. The pressure regulating unit 170 arranged in the bypass is based, for example, on the formation of a gas cushion or on the use of a flexible membrane. In the exemplary embodiment according to FIG. 2, an outlet pressure of 1 bar is achieved in the region of the sample chamber at a system pressure of e.g. 20 bar. This allows a reproducible sample to be taken in a defined and simple manner.

In the exemplary embodiment shown in FIG. 3, the sample removal device 1 is also connected to a system part 2 by means of a flange connection, and a feed device with a line arrangement 4 is present, at the discharge portion or discharge of which a sample holder 16 can be arranged alternating with a waste holder 15. The adjustment between the sample holder 16 in the sample removal position and the waste holder 15 in the waste removal position is also carried out by means of an adjustment device 3, wherein in this exemplary embodiment the adjustment device 3 is designed as a linear table. In this exemplary embodiment, the line arrangement 4 also contains a closure device which has a temperature-control device 13, in particular having the design described above, for the defined supply of liquid medium as a sample. Before the sample is removed, at least a quantity of waste present in the line arrangement 4 is discharged into the waste holder 15 in a rinsing process. In the line arrangement, in this case following a pressure equalization device 12, in particular a Tesla valve, a dosing lance is installed by means of which a laminarization portion 14 is formed for the liquid medium passed through and a connection is created to a control slide present in the adjustment device 3 or an adjustment part, wherein the laminarization portion 14 is closed by the control slide or opens in the waste removal position or the sample removal position. In addition to the mechanical closure created, for example with an opening width of 1 mm to 3 mm, the liquid medium, e.g. a salt flow, can be efficiently cooled to form a sealing plug and heated to dissolve it.

As shown in FIG. 4, a nozzle portion is formed in the inlet area of the line arrangement 4, which nozzle portion narrows continuously, e.g. conically, towards the inlet area or towards the system part 2 and causes an active pressure reduction of the liquid medium coming from the system part 2 by enlarging the pipe cross section at a constant flow rate. The subsequent pressure equalization device 12, for example the Tesla valve, then serves to further reduce the pressure or to equalize gas or medium pressures.

As shown in FIG. 5, the adjustment device 3 designed as a linear table has a guide part 30 and a drive unit 31, which for example engages by means of a gear wheel in a rack for adjusting the adjustment part of the adjustment device 3. The adjustment part has a sample removal part 32 with the sample holder 16 and a waste removal part 36 which is coupled to the waste holder 15 and has a free jet piece 33 leading to the waste removal part 36, via which a waste quantity of the removed medium can be guided into the waste holder 15. Furthermore, the linear table can be provided with a closure part 34 for closing the outlet of the line arrangement 4 in a rest position and also with a freezing part 35 in order to form a sealing plug by freezing the liquid medium in the outlet region of the line arrangement 4. Furthermore, a heating device can be integrated into the linear table as a trace heating device for dissolving the sealing plug for the removal of the liquid medium.

The pressure equalization device 12, in particular the Tesla valve and the nozzle part 110, are permanently heated, for example passively by the heat of the liquid medium or salt circuit and/or are actively trace heated in order to avoid plug formation. The laminarization portion 14, or the dosing lance, is unheated and is passively cooled from one side by the freezing part 35 in the neutral position (when the freezing part 35 is located underneath), so that a sealing plug is formed in the laminarization portion or the dosing lance, which prevents the medium flow from the freezing part 35 or the discharge portion of the line arrangement 4 if no medium sample is removed.

When removing a sample, the heating device of the linear table in the area of the free jet piece 33 (zone 1), the sampling part 32 (zone 2) and the closure part 34 (zone 3) is switched on and heated e.g. to approximately 300° C. In the process, the line portion in question, in particular the laminarization portion 14 or the dosing lance, heats up and the sealing plug, for example a salt plug, dissolves by melting. The adjustment part of the linear table moves from zone 3 (closing part) to the position of zone 1 (free jet part), and liquid medium flows into the waste holder 15 or the waste container. After rinsing the sample removal device, which can be determined for example depending on the increase in weight of the waste holder or the waste container, the linear table is placed in the position of zone 2 (sample removal part). The sample holder or a sample container is filled with a relevant amount of liquid medium or salt. After filling the sample holder, the linear table is placed in the position of the freezer portion (zone 4). At the same time as the adjustment, the heating of the laminarization portion 14, or the dosing lance, by the heating device or trace heating is switched off. A sealing plug forms in the laminarization portion 14.

With the corresponding function and analogous components, such as the linear table, an embodiment of the sample removal device 1 with a rotary table can also be established.

The sample removal device 1 can be used in any fluid system that works with liquid, corrosive media, in particular at temperatures above 100° C., preferably above 150° C. The removal of samples for later analysis can be carried out automatically during operation, wherein no change to the operating parameters is required, as may be necessary for a person taking samples in order not to endanger the person. Sample removal is or can be carried out automatically, wherein appropriate controlling via control technology is possible. Sample removal can be carried out either at predefined times, e.g. at constant intervals, or depending on events, including on weekends or at night. Sampling is carried out reproducibly and always in the same way. Due to the intrinsic pressure regulation, a sample can also be taken from pressurized areas without endangering persons.

The sample removal device can be easily adapted to suit the system or system part 2 (such as a pressurized pipe, container, valve or the like). Pressure fluctuations in system parts are compensated by the sample removal device with simple components, wherein a corresponding pressure reduction or pressure difference regulation takes place during sample removal between the internal system pressure and the sample chamber.

The sample is taken from a representative, relevant medium-carrying area of the system to avoid removal from dead space volumes or non-representative peripheral areas. The sample is advantageously removed, for example, from a continuously flowing free jet and in particular after flushing the sample removal device with system fluid, wherein the medium flow or salt flow can be interrupted in a controlled manner.

By forming the closure device by means of the temperature-control device 13 while freezing the extracted medium, leaks and unwanted salt discharge are avoided, and salt creep into seals and other gaps after sample removal is prevented.

1. A sample removal device (1) for removing a sample from a liquid medium located in a system, with a sample holder (16) into which the removed sample can be introduced via a feed device,
characterized in that
the feed device has a line arrangement (4) which is provided on the inlet side with a connection unit (10) which is or can be coupled in a medium-conducting manner to a system part (2) of the system and on the outlet side with a discharge portion which is or can be brought into connection, in a medium-conducting manner, with the sample holder (16), and has an openable and closable closure device.

2. The sample removal device according to claim 1,
characterized in that
the feed device has a pressure-reducing device in an inlet area.

3. The sample removal device according to claim 2,
characterized in that
the pressure reducing device has a pipe (11) provided with a reduced cross section relative to the connection unit (10) or a nozzle part (110) with a narrowing part directed towards the inlet side.

4. The sample removal device according to claim 2,
characterized in that
the pressure reducing device has a pressure compensation device (12) arranged downstream of the optionally present nozzle part (11), in particular designed as a passive fluidic valve, for example a Tesla valve.

5. The sample removal device according to claim 1
characterized in that
the feed device has a laminarization portion (14), in particular designed as a dosing lance, wherein the laminarization portion (14) is arranged downstream of the pressure-reducing device in the flow direction when designed according to claim 2.

6. The sample removal device according to claim 1
characterized in that
the closure device can be automatically controlled in an event-dependent and/or time-dependent manner depending on the sample size to be taken and/or the temporal sequence of the sampling.

7. The sample removal device according to claim 1.
characterized in that
the closure device, preferably arranged in the outlet region of the feed device, has a temperature-control device (13) which, for closing, has a freezing device which forms a sealing plug by freezing the medium, in particular by free or forced convection, and, for opening, has a heating device which dissolves the sealing plug, in particular by preventing the convection by means of an insulating body or air flow inhibitor.

8. The sample removal device according to claim 7,
characterized in that
the freezing device has a fan (132) generating a cooling air flow around a line portion of the line arrangement (4), in particular around the laminarization portion (14).

9. The sample removal device according to claim 7,
characterized in that
the heating device has an actively energized trace heating system and/or is operated passively using the heat of the supplied medium.

10. The sample removal device according to claim 7,
characterized in that
the temperature control device (13) has a heat-conducting unit (131) which is connected to the line arrangement (4) in a heat-conducting manner and in particular is provided with cooling fins (5).

11. The sample removal device according to claim 1,
characterized in that
the feed device has a pressure difference regulating device (17) assigned to the line arrangement (4), which comprises a pressure regulating unit (170) arranged in a bypass line (171).

12. The sample removal device according to claim 1,
characterized in that
the feed device is provided on the outlet side with an adjusting device (3) having a sample removal part (32) and a waste removal part (36), which adjusting device comprises an adjusting part mounted on a support unit, wherein the sample holder (16) is assigned to the sample removal part (32) and a waste holder (15) is assigned to the waste removal part (36).

13. The sample removal device according to claim 12.
characterized in that
the adjustment device (3) is designed as a linear table or rotary table, which further comprises a guide part (30) and a drive unit (31) for adjusting the adjustment part from a rest position, in which the discharge portion of the line arrangement is closed, into a waste removal position, in which the waste removal part (36) is assigned to the discharge portion of the line arrangement (4), or into a sample removal position, in which the sample removal part (32) is assigned to the discharge portion of the line arrangement (4), and back.

14. A method for removing a sample from a liquid medium located in a system part (2) by means of a sample holder (16) into which the sample is introduced via a feed device,
characterized in that
a line arrangement (4) of the feed device is connected to the system part (2) and a defined quantity of the medium is fed as a sample into the sample holder (16) by opening the flow path through the line arrangement (4), and after reaching the defined quantity in the sample holder (16) the flow path is closed.

15. The method according to claim 14,
characterized in that
the flow path is closed by freezing the medium in a portion of the line arrangement (4) to form a sealing plug, and in that the flow path is opened by dissolving the sealing plug by means of heat.

16. The method according to claim 14,
characterized in that
before removing the sample, a waste quantity of the medium located at least in the line arrangement (4) is conducted into a waste holder (15) by opening the flow path and then closing it.

17. The sample receiving device according to claim 1 for removing a sample from a chemical reactor or a storage device, such as a thermal storage device, wherein the liquid medium is a corrosive, in particular saline fluid at a temperature above room temperature, in particular in the range between 100° C. and 1600° C.

18. An application of the method for removing a sample from a liquid medium located in a system part (2) of a system according to one of claims claim 14, wherein the system is a chemical reactor or a storage device, such as a thermal storage device, and the liquid medium is a corrosive, in particular saline fluid, in particular at a temperature above room temperature, in particular in the range between 100° C. and 1600° C.
